(19) United States
(12) Patent Application Publication
(10) Pub. No.: US 2013/0023683 A1
(43) Pub. Date: Jan. 24, 2013

(54) ALKALI METAL AND ALKALINE EARTH METAL GLYCERATES FOR THE DEACIDIFICATION AND DRYING OF FATTY ACID ESTERS

(71) Applicants: Johannes RUWWE, Niederkassel (DE); Martin LICHTENHELDT, Koeln (DE); Michael FRANK, Bonn (DE); Axel BEU, Troisdoft (DE)

(72) Inventors: Johannes RUWWE, Niederkassel (DE); Martin LICHTENHELDT, Koeln (DE); Michael FRANK, Bonn (DE); Axel BEU, Troisdoft (DE)

(73) Assignee: EVONIK DEGUSSA GMBH, Essen (DE)

(21) Appl. No.: 13/552,707

(22) Filed: Jul. 19, 2012

(30) Foreign Application Priority Data
Jul. 21, 2011 (DE) 10 2011 079 550.2

(51) Int. Cl. C11B 3/02; C09K 3/00

(52) U.S. Cl. 554/200; 252/182.12

(57) ABSTRACT

Provided is a composition comprising an alkali metal glycerate or an alkaline earth metal glycerate and glycerol, and a method for preparing the same. Also provided are methods for removing a fatty acid from a fatty acid-comprising glyceride or a fatty acid alkyl ester (deacidifying) or drying a glyceride or fatty acid alkyl ester, involving contacting a mixture of the fatty acid and the fatty acid-comprising glyceride or the fatty acid alkyl ester, or mixing the glyceride or fatty acid alkyl ester, with the composition.

### CROSS-REFERENCE TO RELATED APPLICATIONS

The present application is claims the benefit of the filing date of German Application No. 10 2011 079 550.2, filed on Jul. 21, 2011, the text of which is incorporated by reference.

### STATEMENT REGARDING FEDERALLY SPONSORED RESEARCH OR DEVELOPMENT

Not Applicable.

### THE NAMES OF THE PARTIES TO A JOINT RESEARCH AGREEMENT

Not Applicable.

### REFERENCE TO A “SEQUENCE LISTING,” A TABLE, OR A COMPUTER PROGRAM LISTING APPENDIX SUBMITTED ON A COMPACT DISC AND AN INCORPORATION-BY-REFERENCE OF THE MATERIAL ON THE COMPACT DISC

Not Applicable.

### BACKGROUND OF THE INVENTION

1. Field of the Invention

The present invention relates to compositions comprising alkali metal glycerates and glycerol and to the use thereof for the deacidification and drying of fatty acid esters.

Fatty acid alkyl esters of monohydric alcohols have for some time found an important application in the use as biodiesel, a replacement for fossil diesel based on renewable raw materials.

The production of biodiesel generally takes place by means of base-catalyzed transesterification of triglycerides (The Biodiesel Handbook, G. Knothe, J. van Gerpen, J. Krahl, Ed. AOCS Press (2005); Biodiesel—The comprehensive handbook, M. Mittelbach, C. Remschmidt (2004); Bioresource Technology 2004, 92, 297; Applied Energy 2010, 87, 1083; Chimica Oggi/Chemistry today 2008, 26).

For this transesterification, it is advantageous if the glyceride used, in particular triglyceride, is free as free of water and fatty acid as possible. Fatty acids can neutralize the alkaline catalyst, necessitating the use of a larger amount of catalyst. Water can lead to the increased formation of soaps as by-products, which may lower the yield. Both effects can also hinder the separation of the released glycerol from the product.

Biodiesel can likewise be produced by means of acid-catalyzed esterification of fatty acids with monohydric alcohols, in particular methanol or ethanol (The Biodiesel Handbook (2nd edition), G. Knothe, J. Krahl, J. van Gerpen, Ed. AOCS Press (2009); WO 95/02661; Adv. Synth. Catal. 2006, 348, 75). In this reaction, a mixture of biodiesel, unreacted fatty acids, unreacted alcohol, and released water is often obtained. In general, for use as biodiesel, the mixture must also be freed of the by-products.

It is possible to remove fatty acids from glycerides, in particular triglycerides, using standard refining processes, such as, for example, distillation or neutralization (A. Thomas in Ullmann's Encyclopedia of Industrial Chemistry—Fats and Fatty Oils). A disadvantage of this approach can be the high energy expenditure of distillation and/or the fact that water-containing neutralizing agents, such as sodium hydroxide solution, are used and increase the water content further.

Although water can be removed from the triglyceride by distillation, the simultaneous presence of water and an alkali metal hydroxide may lead not only to neutralization, but also to saponification.

In order to separate biodiesel from fatty acids, distillation can likewise be used. However, distillation under these circumstances is usually quite expensive since the boiling points of the fatty acids and corresponding fatty acid alkyl esters can be close together and a high input of energy is often required. However, water and alcohols, such as methanol or ethanol, can be separated off relatively easily from the biodiesel by distillation.

2. Description of the Related Art

WO 95/02661 describes how a mixture of biodiesel, fatty acids, and further by-products from an esterification process is passed to a biodiesel process by transesterification, during which the fatty acids are converted to their corresponding soaps, dissolved in the glycerol phase and thus separated off from the biodiesel.

A disadvantage of this process is that the capacity of a reactor, which is actually intended for the transesterification and not the work-up of a stream of an esterification, can be reached. It is likewise disadvantageous that, upon introducing the mixture of biodiesel, fatty acids, and further by-products into the transesterification reactor, an additional amount of alkaline catalyst has to be added which, depending on the type of catalyst, increases costs. Furthermore, when using alkali metal hydroxides, besides the neutralization, at least partial saponification, and thus a loss in yield, can also occur.

It was an object of the present invention to provide a process in which a fatty acid-containing glyceride or a fatty acid-containing fatty acid alkyl ester, for example biodiesel, can be freed from fatty acids simply and, as far as possible, in an anhydrous environment.

According to the invention, this object can be achieved by mixing a fatty acid-containing glyceride or a fatty acid-containing fatty acid alkyl ester with a composition comprising at least one alkali metal or alkaline earth metal glycerate and glycerol, and subjecting the mixture to a subsequent phase separation.

Accordingly, the present invention firstly provides compositions comprising at least one alkali metal or alkaline earth metal glycerate and glycerol, where the water content is preferably at most 3% by weight, based on the composition, in particular 0.01 to 1% by weight, and very particularly preferably 0.1 to 0.5% by weight.

The present invention further provides the use of compositions comprising at least one alkali metal or alkaline earth metal glycerate and glycerol for removing fatty acids from fatty acid-containing glycerides or fatty acid alkyl esters and/or for drying glycerides or fatty acid alkyl esters.

Preferably, compositions comprising at least one alkali metal or alkaline earth metal glycerate and glycerol, in which the water content is at most 3% by weight, based on the composition, in particular 0.01 to 1% by weight, and very particularly preferably 0.1 to 0.5% by weight, are used for removing fatty acids from fatty acid-containing glycerides or fatty acid alkyl esters and/or for drying glycerides or fatty acid alkyl esters.

An essential constituent of the compositions according to the invention is the alkali metal or alkaline earth metal glycerates present. Alkali metal glycerates are known per se to the person skilled in the art. Alkali metal glycerates can be prepared e.g. as described in WO 2009/067809 or in J. Appl. Polym. Sci. 2003, 87, 2100, or in “Chemical Properties and Derivatives of Glycerine” (1963).

ES 2 277 727 describes the use of alkali metal and alkaline earth metal salts of glycerol as transesterification catalysts for biodiesel production. DE 44 36 517 describes the use of sodium or potassium glycerate as transesterification catalyst in solution in glycerol in a mixture with methanol or ethanol for producing fatty acid methyl or ethyl esters. WO 97/33956 discloses the preparation of virtually anhydrous alkali metal glycerate solutions and the use thereof as a catalyst for transesterification reactions. A similar reaction is described in EP 0 428 249, in which alkali metal glycerates are constituents of a catalyst mixture.

DE 199 25 871 describes the use of the glycerol phase obtained in a biodiesel process, which still comprises alkaline catalyst, for removing fatty acids in triglycerides which are intended to be converted to biodiesel. This process is based on the neutralization and simultaneous extraction of the fatty acids in the glycerol phase.

If this returned glycerol phase does not contain an amount of alkaline catalyst sufficient for neutralizing the fatty acids, either additional amounts of catalyst, such as alkali metal hydroxides or alkali metal alcoholates, should be added. The disadvantage of this process is that the returned glycerol phase can contain water or, upon adding alkali metal hydroxides to the glycerol phase, water is released which, in the presence of alkaline media, leads to the saponification of triglycerides or of other fatty acid alkyl esters. If it is necessary to adapt the alkalinity of the glycerol phase by adding alkali metal alcoholates, higher costs can arise.

EP 0 806 471 describes the use of glycerol or a glycerol phase during the recovery of ethanol from a mixture of fatty acid ethyl ester, ethanol, and water, wherein the glycerol used retards the water during this distillation process and permits the recycling of ethanol with a lower water content than without using the glycerol. A disadvantage of this process is that, despite the glycerol used, water can furthermore interfere with the transesterification process, meaning that saponification reactions can occur.

DE 43 01 686 describes the use of glycerol or a glycerol phase for washing a crude fatty acid alkyl ester from a transesterification process. In this step, although a certain purification of the crude fatty acid alkyl ester is achieved, a further post-treatment with an adsorbent is nevertheless required. Furthermore, this process is not suitable for deacidifying a fatty acid alkyl ester.

### BRIEF SUMMARY OF THE INVENTION

Surprisingly, it has now been found that compositions comprising at least one alkali metal or alkaline earth metal glycerate and glycerol, in which the water content is at most 3% by weight, based on the composition, are advantageously suitable for deacidifying fatty acid-containing fatty acid esters.

The alkali metal or alkaline earth metal for the alkali metal or alkaline earth metal glycerates is in particular selected from the group consisting of lithium, sodium, potassium, magnesium or calcium, preferably sodium or potassium. For the purposes of the present invention, alkali metal or alkaline earth metal glycerates are understood as meaning either monovalent or polyvalent salts of glycerol, depending on the cation.

### BRIEF DESCRIPTION OF THE SEVERAL VIEWS OF THE DRAWINGS

Not Applicable.

### DETAILED DESCRIPTION OF THE INVENTION

The fraction of the alkali metal or alkaline earth metal glycerate in the composition is preferably between 3 and 40% by weight, more preferably between 7 and 15% by weight, based on the composition. Preferably, the compositions according to the invention consist of glycerol, 3 to 40% by weight, preferably 7 to 15% by weight, of alkali metal or alkaline earth metal glycerates, and at most 3% by weight, in particular 0.01 to 1% by weight, and very particularly preferably 0.1 to 0.5% by weight, of water, the sum of all of the constituents being 100% by weight.

The compositions according to the invention, comprising at least one alkali metal or alkaline earth metal glycerate and glycerol, are obtained by reacting the corresponding alkali metal hydroxides or alkaline earth metal hydroxides or aqueous solutions thereof with glycerol. Accordingly, processes for the preparation of the compositions according to the invention comprising the reaction of alkali metal hydroxides or alkaline earth metal hydroxides or solutions thereof with glycerol are likewise provided by the present invention.

The glycerol present in the compositions according to the invention and/or the glycerol used in the processes according to the invention can originate from all sources known to the person skilled in the art. Preference is given to using glycerol liberated in the production of biodiesel, and particular preference is given to using crude glycerol liberated in the production of biodiesel which has been freed from methanol.

The removal of water, which is either already present in the glycerol, or is introduced as solvent into the reaction mixture and is released by the reaction, to a content of at most 3% by weight, based on the composition, preferably takes place distillatively. The distillative removal of the water can take place with or without entrainers, at atmospheric pressure or else at reduced pressure. Customary temperatures during the distillation are in the range from 50 to 140° C., in particular 60 to 130° C., and very particularly preferably 70 to 120° C.

Preferably, the distillation takes place at pressures between 10 mbar and atmospheric pressure.

Moreover, an antifoam can additionally be added during or before the distillation. Suitable antifoams are silicone oils, for example.

Suitable apparatuses for producing the compositions according to the invention are stirred-tank reactors or thin-film evaporators.

If the compositions according to the invention have an excessively high viscosity, an alcohol, in particular a low viscosity, anhydrous alcohol, can be added. For this purpose, preference is given to using methanol, ethanol, propanol or n-butanol, particular preference being given to using the alcohol which is used in the respective biodiesel production.

Suitable entrainers are water-immiscible solvents which can likewise be removed by distillation from the composition comprising at least one alkali metal or alkaline earth metal glycerate and glycerol following removal of the water. Preference is given to using hexane, heptane, toluene, benzene, cyclohexane, methylcyclohexane, and/or ethylcyclohexane as an entrainer.

Alternatively, the compositions according to the invention can also be produced by reacting glycerol with the corresponding alkali metals or alkaline earth metals or amalgams thereof.

It is likewise possible to prepare the compositions according to the invention by reacting glycerol with suitable basic alkali metal or alkaline earth metal compounds. Suitable basic alkali metal or alkaline earth metal compounds are, e.g., sodium hydride, potassium hydride, calcium hydride, sodium amide, potassium amide, methyllithium, n-butyllithium, sec-butyllithium, or tert-butyllithium.

The compositions according to the invention are preferably used for removing fatty acids from fatty acid-containing glycerides, in particular triglycerides, or fatty acid alkyl esters. The present invention thus also provides methods for removing fatty acids from fatty acid-containing glycerides or fatty acid alkyl esters and/or for drying glycerides or fatty acid alkyl esters, where a composition according to the invention comprising at least one alkali metal or alkaline earth metal glycerate and glycerol, in which the water content is at most 3% by weight, based on the composition, is used.

For the purposes of the present invention, glycerides means mono-, di- and triglycerides.

In the simplest embodiment of a process according to the invention, the corresponding glyceride or the fatty acid alkyl ester is mixed with the composition according to the invention. The resulting phases, a glycerol phase and a glyceride or fatty acid alkyl ester phase, are then separated by phase separation.

The mixing of the fatty acid-containing glycerides or fatty acid esters with the compositions according to the invention can take place, for example, by stirring in a stirred-tank reactor or by mixing in a static mixer.

Here, the alkali metal or alkaline earth metal glycerate present neutralizes the fatty acids present and converts these to the corresponding soaps according to the following reaction equation

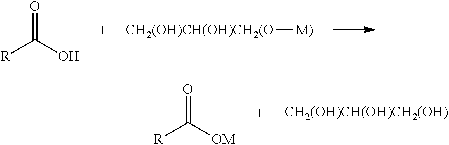

where R is alkyl or alkenyl, in particular with a chain length of 5-23 carbon atoms, and M=Li, Na, K, 0.5 Mg, or 0.5 Ca.

The soaps formed dissolve in the glycerol, which is immiscible with the glycerides and fatty acid esters and forms a heavy lower phase. This heavy phase can then be separated off by phase separation, the resulting soaps also being separated off in this way.

According to the invention, the phase separation can take place by gravity or else by means of a separator or a centrifuge.

Suitable glycerides as starting materials for the process according to the invention are in particular mono-, di- and triglycerides of the general formula (I)

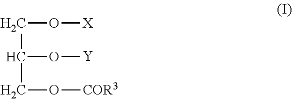

in which X═COR¹ or H, Y═COR² or H, and R¹, R² and R³, which may be identical or different, are aliphatic hydrocarbon groups having 3 to 23 carbon atoms, where these groups can optionally be substituted with a OH group, or any desired mixtures of such glycerides.

First, in glycerides according to formula (I), one or two fatty acid esters can be replaced by hydrogen. The fatty acid esters R¹CO—, R²CO—, and R³CO— are derived from fatty acids having 3 to 23 carbon atoms in the alkyl chain. R¹ and R² or R¹, R², and R³ can be identical or different in the aforementioned formula if they are di- or triglycerides. The radicals R¹, R², and R³ belong to the following groups:
a) alkyl radicals, which may be branched but are preferably straight-chain and have 3 to 23, preferably 7 to 23, carbon atoms;
b) olefinically unsaturated aliphatic hydrocarbon radicals, which may be branched but are preferably straight-chain, and which have 3 to 23, preferably 11 to 21, and in particular 15 to 21, carbon atoms and which contain 1 to 6, preferably 1 to 3, double bonds, which may be conjugated or isolated;
c) monohydroxy-substituted radicals of types a) and b), preferably olefinically unsaturated olefin radicals which have 1 to 3 double bonds, in particular the ricinolic acid radical.

The acyl radicals R¹CO—, R²CO—, and R³CO— of such glycerides which are suitable as starting materials for the process of the present invention are derived from the following groups of aliphatic carboxylic acids (fatty acids):
a) alkanoic acids or alkyl-branched, in particular methyl-branched, derivatives thereof which have 4 to 24 carbon atoms, such as, for example, butyric acid, valeric acid, caproic acid, heptanoic acid, caprylic acid, perlargonic acid, capric acid, undecanoic acid, lauric acid, tridecanoic acid, myristic acid, pentadecanoic acid, palmitic acid, margaric acid, stearic acid, nonadecanoic acid, arachidic acid, behenic acid, lignoceric acid, 2-methylbutanoic acid, isobutyric acid, isovaleric acid, pivalic acid, isocaproic acid, 2-ethylcaproic acid, the positional-isomeric methylcapric acids, methyllauric acids and methylstearic acids, 12-hexylstearic acid, isostearic acid, or 3,3-dimethylstearic acid;
b) alkenoic acids, alkadienoic acids, alkatrienoic acids, alkatetraenoic acids, alkapentaenoic acids, and alkahexaenoic acids, and alkyl-branched, specifically methyl-branched, derivatives thereof having 4 to 24 carbon atoms, such as crotonic acid, isocrotonic acid, caproleic acid, 3-lauroleic acid, myristoleic acid, palmitoleic acid, oleic acid, elaidic acid, erucic acid, brassidic acid, 2,4-decadienoic acid, linoleic acid, 11,14-eicosadienoic acid, eleostearic acid, linolenic acid, pseudoeleostearic acid, arachidonic acid, 4,8,12,15,18,21-tetracosahexaenoic acid, or trans-2-methyl-2-butenoic acid;
c₁) monohydroxyalkanoic acids having 4 to 24, preferably 12 to 24, carbon atoms, preferably unbranched, such as hydroxybutyric acid, hydroxyvaleric acid, hydroxycaproic acid, 2-hydroxydodecanoic acid, 2-hydroxytetradecanoic acid, 15-hydroxypentadecanoic acid, 16-hydroxyhexadecanoic acid, or hydroxyoctadecanoic acid; and
c₂) monohydroxyalkenoic acids having 4 to 24, preferably 12 to 22, in particular 16 to 22, carbon atoms (preferably unbranched), and having 1 to 6, preferably 1 to 3, and in particular one, ethylenic double bond, such as ricinoleic acid or ricinelaidic acid.

Preferred starting materials for the process according to the invention are in particular the natural fats, which are mixtures of predominantly triglycerides and small fractions of diglycerides and/or monoglycerides. These glycerides, in most cases, are also mixtures and contain different types of fatty acid radicals in the aforementioned range, in particular those having 8 and more carbon atoms. Examples which may be mentioned are vegetable fats, such as olive oil, coconut fat, palm kernel fat, babassu oil, palm oil, palm kernel oil, peanut oil, rapeseed oil (colza oil), ricinus oil, sesame oil, sunflower oil, soya oil, hemp oil, poppy oil, avocado oil, cotton seed oil, wheat germ oil, corn germ oil, pumpkin seed oil, tobacco oil, grapeseed oil, jatropha oil, algae oil, karanja oil (oil of Pongamia pinnata), camelina oil (linseed dodder oil), cocoa butter or else plant tallows, also animal fats, such as beef tallow, pig fat, chicken fat, bone fat, mutton tallow, Japan tallow, whale oil and other fish oils, and also cod-liver oil. However, it is likewise possible also to use uniform tri-, di- and monoglycerides, be they isolated from natural fats or obtained by a synthetic route. Examples which may be mentioned here are tributyrin, tricapronin, tricaprylin, tricaprinin, trilaurin, trimyristin, tripalmitin, tristearin, triolein, trielaidin, trilinoliin, trilinolenin, monopalmitin, monostearin, monoolein, monocaprinin, monolaurin, and monomyristin, or mixed glycerides, such as palmitodistearin, distearoolein, dipalmitoolein, or myristopalmitostearin.

The specified glycerides, i.e. mono-, di-, or triglycerides, in particular fatty acid glycerides, can be converted to fatty acid alkyl esters (biodiesel) in a subsequent transesterification process. This transesterification is preferably carried out in the presence of an alkaline catalyst with methanol, ethanol, n-propanol, isopropanol, n-butanol, or isobutanol, particularly preferably methanol and ethanol.

Very particular preference is given to transesterification processes which are carried out with alcoholates as alkaline catalysts in an anhydrous medium.

Moreover, within the context of the present invention, preference is also given to using fatty acid alkyl esters. That is, fatty acid alkyl esters from all sources known to the person skilled in the art can be deacidified by means of compositions and processes according to the present invention.

The fatty acid esters treated in this way can be further reacted or used in a different form.

Examples of corresponding fatty acid alkyl esters are in particular alkyl esters of the following carboxylic acids (fatty acids):
a) alkanoic acids or alkyl-branched, in particular methyl-branched, derivatives thereof which have 4 to 24 carbon atoms, such as, for example, butyric acid, valeric acid, caproic acid, heptanoic acid, caprylic acid, perlargonic acid, capric acid, undecanoic acid, lauric acid, tridecanoic acid, myristic acid, pentadecanoic acid, palmitic acid, margaric acid, stearic acid, nonadecanoic acid, arachidic acid, behenic acid, lignoceric acid, 2-methylbutanoic acid, isobutyric acid, isovaleric acid, pivalic acid, isocaproic acid, 2-ethylcaproic acid, the positional-isomeric methylcapric acids, methyllauric acids and methylstearic acids, 12-hexylstearic acid, isostearic acid, or 3,3-dimethylstearic acid;
b) alkenoic acids, alkadienoic acids, alkatrienoic acids, alkatetraenoic acids, alkapentaenoic acids, and alkahexaenoic acids, and alkyl-branched, specifically methyl-branched, derivatives thereof having 4 to 24 carbon atoms, such as, for example, crotonic acid, isocrotonic acid, caproleic acid, 3-lauroleic acid, myristoleic acid, palmitoleic acid, oleic acid, elaidic acid, erucic acid, brassidic acid, 2,4-decadienoic acid, linoleic acid, 11,14-eicosadienoic acid, eleostearic acid, linolenic acid, pseudoeleostearic acid, arachidonic acid, 4,8,12,15,18,21-tetracosahexaenoic acid, or trans-2-methyl-2-butenoic acid;
c₁) monohydroxyalkanoic acids having 4 to 24 carbon atoms, preferably having 12 to 24 carbon atoms, preferably unbranched, such as, for example, hydroxybutyric acid, hydroxyvaleric acid, hydroxycaproic acid, 2-hydroxydodecanoic acid, 2-hydroxy-tetradecanoic acid, 15-hydroxypentadecanoic acid, 16-hydroxyhexadecanoic acid, or hydroxyoctadecanoic acid; and
c₂) monohydroxyalkenoic acids having 4 to 24, preferably having 12 to 22, in particular 16 to 22, carbon atoms (preferably unbranched) and having 1 to 6, preferably 1 to 3, and in particular one, ethylenic double bond, such as ricinoleic acid or ricinelaidic acid.

The fatty acid alkyl esters used according to the invention are derived from the aforementioned carboxylic acids by esterification with alcohols. In particular, the fatty acid alkyl esters are esters with monohydric alcohols. For the purposes of the present invention, monohydric alcohols are understood as meaning alcohols with only one OH group.

Examples of monohydric alcohols are methanol, ethanol, n-propanol, isopropanol, n-butanol, isobutanol, sec-butanol or tert-butanol, and also branched or longer-chain, optionally likewise branched alcohols, such as amyl alcohol, tert-amyl alcohol, n-hexanol, and/or 2-ethylhexanol. Preferably, the carboxylic acids specified above are esterified with methanol or ethanol.

If the starting materials used are fatty acid alkyl esters, for example biodiesel, e.g. from an esterification process, these can be washed, optionally further dried, and then used as a biodiesel meeting specifications. In particular, the processes according to the invention are advantageous in the production of biodiesel. Without treatment with the composition according to the invention, it is not possible to meet specifications for biodiesel with regard to the acid number and the ester content by washing and drying the fatty acid alkyl ester. The use of the compositions according to the invention in the processes according to the invention simplifies the access to biodiesel in an advantageous manner.

Even without further details, it is assumed that a person skilled in the art is able to utilize the above description in the widest scope. For this reason, the preferred embodiments and examples are merely to be interpreted as descriptive, but in no way limiting, disclosure.

The present invention is illustrated in more detail below by reference to examples. Alternative embodiments of the present invention are obtainable in an analogous way.

### EXAMPLES

The content of alkali metal glycerates is determined by potentiometric titration. In this, the glycerate is dissolved in demineralized water by stirring for 5 minutes and titrated with 0.25 molar sulfuric acid measuring solution to the equivalence point.

The water content is determined in accordance with DIN 51777 “Determination of the water content by the Karl-Fischer-direct method.” The solvent is methanol, the detection takes place amperometrically at a double platinum electrode.

The soap content is ascertained by titration according to the standard method of the DGF (German Society for Fat Science), Method C-III 15 (97) “Soap in Oils and Fats,” published in “German Standard Methods for Investigating Fats, Fat Products, Surfactants and Related Substances.” Here, the sample is dissolved in ethanol or acetone and titrated with 0.1 molar hydrochloric acid against bromophenol blue as indicator. Alternatively, the end product can be ascertained potentiometrically.

The acid number is ascertained by titration corresponding to the standard method EN 14104:2003 “Products from plant and animal fats and oils—Fatty Acid Methyl Esters (FAME)—determination of the acid number.” Here, part of a sample is dissolved in a solvent mixture and titrated with a dilute potassium hydroxide solution. The indicator used for determining the end point of the titration is phenolphthalein. Alternatively, the end point can be determined potentiometrically.

I) Preparation of Alkali Metal Glycerate Solutions in Glycerol:

1. 10% Strength Solution of Potassium Glycerate in Glycerol with the Help of an Entrainer:

461 g (5.0 mol) of glycerol (pharmaceutical grade) and 200 g of toluene are heated to boiling at atmospheric pressure. 40 g (0.36 mol) of 50% strength aqueous KOH solution are slowly metered in, during which 55 g of water are removed on the water separator (likewise filled with toluene) over the course of ca. 3 hours. Traces of toluene in the product are removed on a rotatory evaporator at 100 to 15 mbar and 90° C.

| | | | |
|---|---|---|---|
| Analysis: | Content of potassium glycerate | 10% | by weight |
| | Water content: | 0.1% | by weight |
| | Viscosity: | 6000 | mPa · s. |

2. 10% Strength Solution of Potassium Glycerate in Glycerol Without Entrainer:

461 g (5.0 mol) of glycerol (pharmaceutical grade) and 41 g (0.36 mol) of 50% strength aqueous KOH solution are heated to boiling in vacuo (190° C., 70 mbar) and water is distilled off. Towards the end of the distillation, the pressure is reduced to ca. 30 mbar. This gives 470 g of a yellowish, clear solution as bottom product.

| | | | |
|---|---|---|---|
| Analysis: | Content of potassium glycerate | 10.0% | by weight |
| | Water content: | 0.18% | by weight |
| | Viscosity: | 4200 | mPa · s. |

3. 15% Strength Solution of Potassium Glycerate in Glycerol by Means of Thin-Film Evaporator Without Entrainer:

A mixture, preheated to 80° C., of 921 g (10.0 mol) of glycerol (pharmaceutical grade) and 124.4 g (1.1 mol) of a 50% strength aqueous KOH solution is passed, at a metering rate between 500 ml/h and 750 ml/h at a pressure of 30 mbar, over a thin-film evaporator, heated to 150° C., with a diameter of 5 cm and a length of 40 cm. This gives a 15.2% strength potassium glycerate solution with a water content of 0.23%.

4. 4% Strength Solution of Potassium Glycerate in Glycerol from Soap-Containing Glycerol Without Entrainer:

461 g of glycerol, which comprises ca. 10% potassium soaps and also small amounts of methanol, is treated with 6 drops of antifoam TEGO 3062 (Evonik Goldschmidt GmbH) and freed from the low-boiling component in vacuo. Then, 25 g (0.22 mol) of 50% strength aqueous KOH solution are added, and at 119° C. and 35 mbar ca. 12.5 g of water are distilled off. This gives 405 g of a yellowish, clear solution as bottom product.

| | | | |
|---|---|---|---|
| Analysis: | Content of potassium glycerate | 4.1% | by weight |
| | Water content: | 0.32% | by weight |
| | Viscosity: | 35 000 | mPa · s. |

5. 15% Strength Solution of Potassium Glycerate in Glycerol from Soap-Containing Glycerol:

513 g of glycerol with a content of 10.1% potassium soaps, 250 g of toluene and 6 drops of antifoam TEGO 3062 (Evonik Goldschmidt GmbH) are heated to 110° C. 56 g (0.5 mol) of 50% strength aqueous KOH solution are metered in and at the same time water is distilled off with a Dean-Stark apparatus. The entrainer toluene is then distilled off in vacuo at 16 mbar and 95° C. This gives 529 g of a viscous yellow liquid.

| | | |
|---|---|---|
| Analysis: | Content of potassium glycerate | 15.9% by weight |
| | Water content: | 0.05% by weight |

6. 20% Strength Solution of Sodium Glycerate in Glycerol with the Help of an Entrainer:

461 g (5.0 mol) of glycerol (pharmaceutical grade) and 200 g of toluene are heated to boiling at atmospheric pressure. 80 g (1.0 mol) of 50% strength aqueous NaOH solution are slowly metered in, during which 110 g of water are removed on a water separator (likewise filled with toluene) over the course of ca. 8 hours. Then, toluene is removed firstly by phase separation, and then traces that are still present are removed on a rotatory evaporator at 100 to 15 mbar and 90° C.

| | | |
|---|---|---|
| Analysis: | Content of sodium glycerate | 20% by weight |
| | Water content: | 0.21% by weight |

7. 5% Strength Solution of Sodium Glycerate in Glycerol from Sodium Metal:

With stirring, 2.2 g (0.1 mol) of sodium metal are added to 221.4 g (1.2 mol) of glycerol. The mixture is heated to ca. 80° C. Stirring is continued until the evolution of hydrogen is no longer observed and the sodium has completely entered into solution (ca. 10 h). This gives a colorless solution.

| | | |
|---|---|---|
| Analysis: | Content of sodium glycerate | 4.6% by weight |
| | Water content: | 0.12% by weight |

8. Setting of the Viscosity of a Potassium Glycerate Solution in Glycerol with Methanol:
a) A 15% strength solution of potassium glycerate solution in glycerol with a viscosity of ca. 6800 mPa·s is admixed with 5% by weight of methanol and intensively stirred. This gives a mixture with a viscosity of 2581 mPa·s.
b) A 15% strength solution of potassium glycerate solution in glycerol with a viscosity of ca. 6800 mPa·s is admixed with 10% by weight of methanol and intensively stirred. This gives a mixture with a viscosity of 1127 mPa·s.

II) Deacidification and Drying of Fatty Acid Esters:

1. Treatment of a Fatty Acid-Containing Triglyceride:

410 g of a rapeseed oil with an acid number of 5.0 mg KOH/g is admixed with 46.5 g of a 9.9% strength by weight potassium glycerate solution (with a water content of 0.18%) in glycerol and stirred for 10 minutes. The mixture is then transferred to a separatory funnel. After 1.5 hours, a phase separation is carried out. This gives 396 g of a light phase (neutralized rapeseed oil) with an acid number of 0.6 mg KOH/g and a water content of 0.01% by weight; the content of potassium soaps is 342 mg/kg.

Furthermore, 45.4 g of a heavy phase (glycerol phase) with a soap content of 18.9% by weight is obtained.

For the conversion of the treated rapeseed oil to biodiesel, significantly less catalyst is required than for the untreated rapeseed oil since less alkaline catalyst is neutralized by fatty acids.

2. Treatment of a Fatty Acid-Containing, Water-Containing Triglyceride:

428 g of a rapeseed oil with an acid number of 9.3 mg KOH/g and a water content of 1.96% by weight is admixed with 81.4 g of a 15.9% strength by weight potassium glycerate solution in glycerol (water content: 0.05%), which comprises ca. 10% by weight of soaps, and stirred for 10 minutes. The mixture is then transferred to a separating funnel. After 1.5 hours, a phase separation is carried out.

This gives 403 g of a light phase (neutralized rapeseed oil) with an acid number of <0.1 mg KOH/g and a water content of 0.08% by weight; the content of potassium soaps is 972 mg/kg.

Furthermore, 96.0 g of a heavy phase (glycerol phase) with a soap content of 27.1% and a water content of 7.8% by weight are obtained.

For the conversion of the treated rapeseed oil to biodiesel, a considerably lower catalyst use is required than for the untreated rapeseed oil since less alkaline catalyst is neutralized by fatty acids.

3. Treatment of a Fatty Acid-Containing Biodiesel:

400 g of a rapeseed methyl ester with an acid number of 10.7 mg KOH/g and a fatty acid methyl ester content of 95.6% are admixed with 97.5 g of a 9.7% strength by weight potassium glycerate solution in glycerol (soap-free, water content 0.54% by weight) and stirred at 40° C. Then, the reaction mixture is placed in a separating funnel for 60 minutes, during which two phases are rapidly formed. The lower glycerol phase is separated off.

This gives 361 g of an upper, light rapeseed methyl ester phase with an acid number of 0.17 mg KOH/g, a water content of 0.013% by weight and a fatty acid methyl ester content of 99% by weight.

4. Treatment of a Fatty Acid-Containing Biodiesel:

396 g of a rapeseed methyl ester with an acid number of 2.51 mg KOH/g and a fatty acid methyl ester content of 95.4% by weight are admixed with 14.6 g of a 14.9% strength by weight potassium glycerate solution in glycerol (soap-free, water content 0.32% by weight) and stirred at 65° C. Then, the reaction mixture is placed in a separating funnel for 60 minutes, during which two phases are rapidly formed. The lower glycerol phase is separated off. The upper phase (393 g) is washed successively with dilute hydrochloric acid and water and then dried on a rotatory evaporator.

This gives rapeseed methyl ester with an acid number of 0.39 mg KOH/g, a water content of 0.025% by weight and a fatty acid methyl ester content of 96.5% by weight.

5. Comparative Experiment, Not According to the Invention: Treatment of a Fatty Acid-Containing Biodiesel:

400 g of a rapeseed methyl ester with an acid number of 2.40 mg KOH/g and a fatty acid methyl ester content of 96.0% by weight are washed twice with water and then dried on a rotatory evaporator.

This gives 396.8 g of rapeseed methyl ester with an acid number of 2.37 mg KOH/g, and a fatty acid methyl ester content of 95.0% by weight.

1. A composition, comprising:
an alkali metal glycerate or an alkaline earth metal glycerate; and
glycerol,
wherein a water content of the composition is at most 3% by weight, based on a total weight of the composition.

2. The composition of claim 1, wherein the water content is 0.01 to 1% by weight, based on the total weight of the composition.

3. The composition of claim 1, wherein the alkali metal glycerate is present and a fraction of the alkali metal glycerate is between 3 and 40% by weight, based on the total weight of the composition.

4. The composition of claim 1, wherein a metal of the alkali metal glycerate or alkaline earth metal glycerate is selected from the group consisting of lithium, sodium, potassium, magnesium, and calcium.

5. The composition of claim 1, wherein a metal of the alkali metal glycerate is present and is lithium.

6. The composition of claim 1, wherein a metal of the alkali metal glycerate is present and is sodium.

7. The composition of claim 1, wherein a metal of the alkali metal glycerate is present and is potassium.

8. The composition of claim 1, wherein a metal of the alkaline earth metal glycerate is present and is magnesium or calcium.

9. The composition of claim 1, further comprising an alcohol.

10. The composition of claim 9, wherein the alcohol is selected from the group consisting of methanol, ethanol, propanol, and n-butanol.

11. A process for preparing the composition of claim 1, the process comprising:
(A) reacting (i) an alkali metal hydroxide, alkaline earth metal hydroxide, a solution of alkali metal hydroxide, or a solution of alkaline earth metal hydroxide, with (ii) glycerol, to obtain a reaction mixture; and
(C) setting a water content of the reaction mixture to at most 3% by weight, based on a total weight of the composition which is obtained.

12. The process of claim 11, wherein the setting (C) comprises removing water by distillation to a content of at most 3% by weight.

13. The process of claim 12, further comprising:
(B) adding a defoamer to the reaction mixture before the distillation.

14. The process of claim 11, comprising feeding the glycerol (ii) to the reacting (A) from a biodiesel process.

15. A process for removing a fatty acid from a fatty acid-comprising glyceride or a fatty acid alkyl ester, the process comprising:
contacting a mixture comprising (i) the fatty acid and (ii-a) the fatty acid-comprising glyceride or (ii-b) the fatty acid alkyl ester, with the composition of claim 1.

16. A process for drying a glyceride or fatty acid alkyl ester, the process comprising:
contacting a mixture comprising (i) the glyceride or (ii) the fatty acid alkyl ester, with the composition of claim 1.

17. The process of claim 16, further comprising:
separating a first phase from a second phase by phase separation, after the contacting,
wherein the contacting comprises mixing (i) the glyceride or (ii) or fatty acid alkyl ester with the composition of claim 1 to obtain the first phase from the second phase.

18. The process of claim 17, wherein the phase separation is carried out by gravity.

19. The process of claim 17, wherein the phase separation is carried out with a separator.

20. The process of claim 17, wherein the phase separation is carried out with a centrifuge.
